(19) United States
(12) Patent Application Publication
(10) Pub. No.: US 2024/0376780 A1
(43) Pub. Date: Nov. 14, 2024

(54) LADDER OUTRIGGER

(71) Applicant: TRIODYNE HOLDINGS LLC, NORTHBROOK, IL (US)

(72) Inventors: Ralph Lipsey BARNETT, Wilmette, IL (US); Peter J. POCZYNOK, Oakbrook Terrace, IL (US); Samuel Benjamin BARNETT, Northbrook, IL (US)

(73) Assignee: TRIODYNE HOLDINGS LLC, NORTHBROOK, IL (US)

(21) Appl. No.: 18/659,914

(22) Filed: May 9, 2024

Related U.S. Application Data
(60) Provisional application No. 63/465,123, filed on May 9, 2023.

(51) Int. Cl. E06C 7/42

(52) U.S. Cl. CPC E06C 7/423

(57) ABSTRACT

An apparatus and method for stabilizing a ladder having rung steps extending between opposing side rails. The apparatus includes a support member configured to mount to at least one of the side rails of the ladder, and a pair of outrigger arms mounted to the support member. The outrigger arms are extendable between a storage position and an extended outrigger position.

### CROSS REFERENCE TO RELATED APPLICATION

This application claims the benefit of U.S. Provisional Application, Ser. No. 63/465,123, filed on 9 May 2023. The co-pending provisional application is hereby incorporated by reference herein in its entirety and is made a part hereof, including but not limited to those portions which specifically appear hereinafter.

### FIELD OF THE INVENTION

This invention relates generally to a ladder safety apparatus and, more particularly, to a projecting outrigger apparatus that is extendable out from a main ladder structure to provide additional stability or to support the ladder.

### BACKGROUND OF THE INVENTION

Frame ladders traditionally have very little lateral resistance, which compromises their use in configurations where overreaching to the side is required or lateral pushing/pulling against fixed objects is demanded to accomplish conventional tasks such as elevated drilling, sawing, or positioning work pieces. One of the classic solutions to overturning is to stabilize objects by broadening their base. In the case of the A-frame ladder, making it sufficiently wide will solve the sideways stability problem, but unfortunately one immediately encounters the practical problem of storing, moving, and maneuvering ladders that are, for example, twice as wide as conventional designs. There is a continuing need to improve ladder safety.

### SUMMARY OF THE INVENTION

A general object of the invention is to provide a projecting outrigger apparatus that is extendable out from a main structure to provide additional stability.

This invention attempts to temporarily increase a width of a ladder base for special circumstances involving excessive leaning or excessive pushing. The outrigger structure of this invention may be customized to adapt to the working terrain and can provide, for example, a threefold enlargement of the ladder base in a quick manner. After deployment, the outrigger arms are stored in a vertical position, thereby having only slight effect on the ladder profile.

The general object of the invention can be attained, at least in part, through an apparatus for stabilizing a ladder having rung steps extending between opposing side rails. The apparatus includes a support member configured to mount to at least one of the side rails of the ladder, and an outrigger arm mounted to the support member. The outrigger arm is extendable between a storage position and an extended outrigger position. In preferred embodiments, a second outrigger arm is also rotatably mounted to the support member or to a second support member on an opposing side of the ladder.

In embodiments, the outrigger arm is rotatably mounted to the support member, wherein the outrigger arm is rotatable between a storage position and an extended outrigger position. In the storage position the outrigger arm is desirably substantially parallel to and/or disposed between the opposing side rails of the ladder.

The support member desirably extends between the opposing side rails of the ladder, and can be embodied as a plate attached to the side rails and at least one of the steps of the ladder. Two outrigger arms are rotatably mounted to the support member, wherein the second outrigger arm is rotatable between the storage position and a second extended outrigger position. In the storage position, the outrigger arms are disposed between the opposing side rails, and between the front and back frame portions of an A-frame ladder, along a longitudinal axis of the ladder. The outrigger arms can be connected to the support member plate by, and rotatable about, a bolt, rivet, or rotatable hinge. The rotation axis of the outrigger arm is desirably substantially parallel to a longitudinal axis of each of the opposing side rails.

The invention further includes an apparatus for stabilizing a ladder, including a support member having opposing ends each adapted to connect to one of the opposing side rails of the ladder. A pair of outrigger arms, each rotatably mounted at a first end to the support member, are rotatable between a storage position between the opposing side rails and a radially extended outrigger position.

The invention further includes a method of stabilizing a ladder having rung steps extending between opposing side rails. The method includes steps of: providing an outrigger arm with a first end connected to the ladder; placing ends of the opposing side rails on a surface; extending a first outrigger arm radially outward from the side rails; and placing a second end of the first outrigger arm against the surface to stabilize the ladder.

Other objects and advantages will be apparent to those skilled in the art from the following detailed description taken in conjunction with the appended claims and drawings.

### BRIEF DESCRIPTION OF THE DRAWINGS

FIG. 1 shows a representative frame ladder.

FIG. 2 shows a ladder safety apparatus according to one embodiment of this invention.

FIG. 3 shows a ladder safety apparatus according to one embodiment of this invention affixed to a ladder and in closed or storage position.

FIG. 4 shows a ladder safety apparatus according to one embodiment of this invention affixed to a ladder and in closed or storage position.

FIG. 5 shows a ladder safety apparatus in an extended or stabilizing position according to one embodiment of this invention.

### DETAILED DESCRIPTION OF THE INVENTION

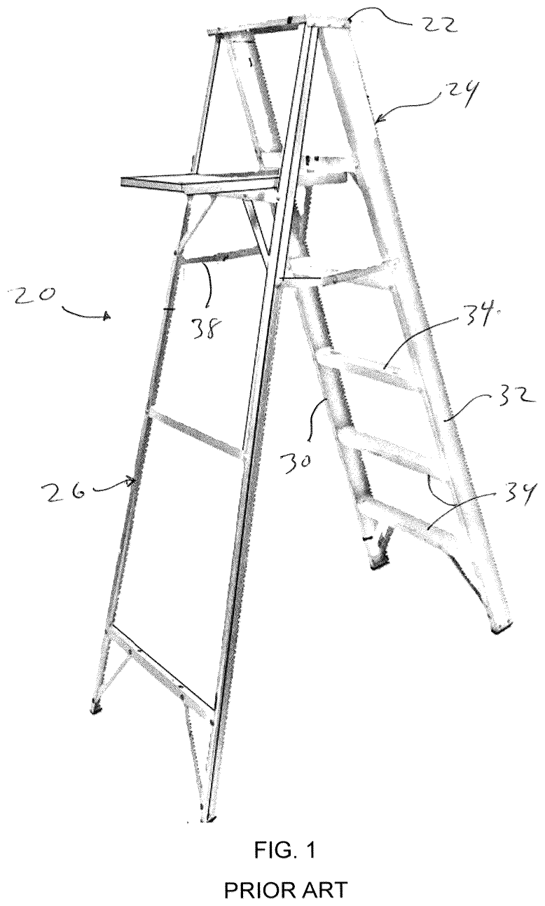

The present invention provides a stability aid for ladders, and particularly A-frame ladders. FIG. 1 shows a representative ladder 20 with a top cap 22, which is the highest structure on the ladder 20 and holds the front frame 24 and the back frame 26 in position for storage or climbing. The front frame 24 is formed of two opposing side rails 30 and 32, which provide the vertical strength of the ladder 20. Between the side rails 30 and 32 are the steps or rungs 34. A spreader 36 fixes the maximum angle between the front frame 24 and the rear frame 26 of the ladder. Brace 38 reinforces the joints between the side rail 30 and 32 and corresponding steps 34.

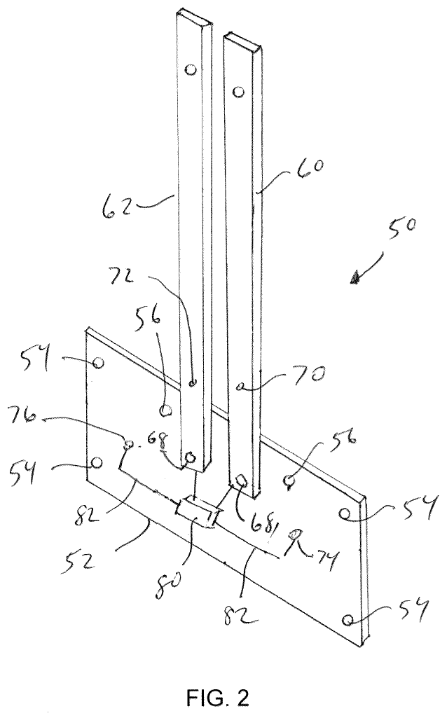

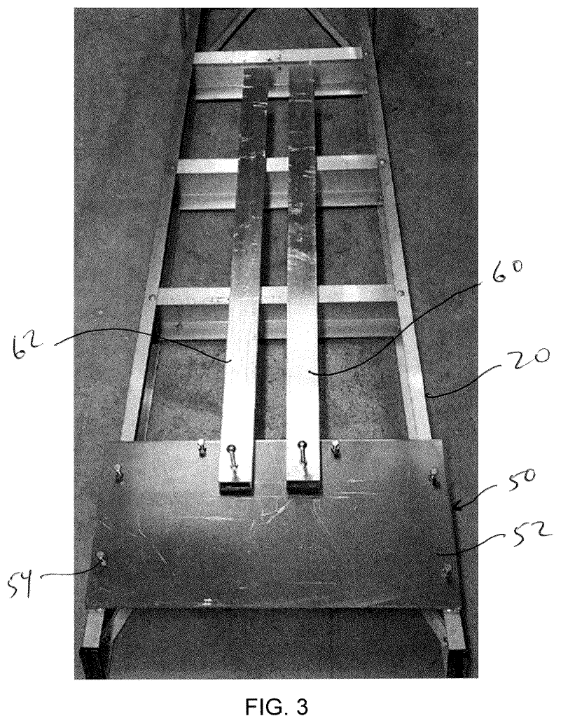

FIG. 2 shows a ladder stabilizing apparatus according to one embodiment of this invention. In particular, FIG. 2 shows an outrigger attachment 50 for a ladder such as shown in FIG. 1. As used herein, “outrigger” refers to a structure that effectively widens the base of the ladder. The apparatus includes a support member 52 which is mountable to at least one of the side rails (30, 32 in FIG. 1) of the ladder. The support member 52 is useful to add structural rigidity to the base of the ladder as well as act as the connection (e.g., a pivot point) between the ladder and the outrigger structure. As shown in FIG. 2 and also FIGS. 3-5, the support member is a rotation plate that secures between, and via opposing ends, to the side members 30 and 32. The illustrated plate 52 includes openings 54 for fasteners. Any suitable fastener or connection means can be used, such as bolts, screws, or welds. In addition, the illustrated plate 52 has opening 56 for fastening to the first ladder step.

Any suitable size, shape, or configuration is available for the support member or rotation plate according to this invention. For example, a slimmer extension or bar can extend between the side rails. Also, two individual support members can be used, one on each side rail to reinforce the side rail for direct attachment of the outrigger to the side rail.

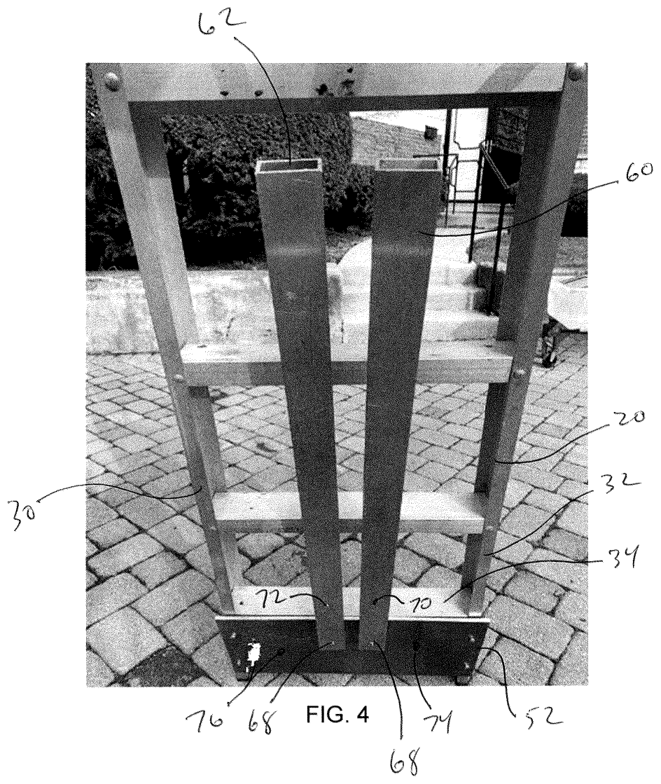

As shown in FIGS. 3 and 4, the support member or rotation plate 52 is bolted to the backside periphery of the lowest front panel of the A-frame ladder 20. At the pre-drilled holes located in the rotation plate 52, quarter inch bolts are drilled into the flanges at the edges of the side rails 30 and 32 and through the backside of the lowest step 34 which is held level with the working surface of the step.

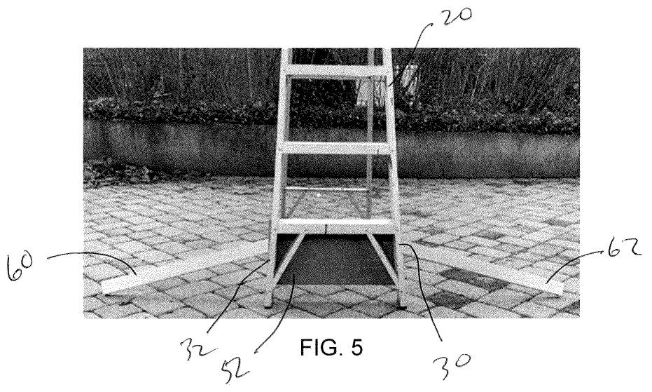

FIG. 2 shows an outrigger structure embodied as two outrigger arms 60 and 62 mounted to the support member 52. The outrigger arms 60 and 62 move between the ‘vertical’ storage position shown in FIG. 2 and a radially extended position, such as shown in FIG. 5. As illustrated, the outrigger arms 60 and 62 are rotably mounted to the support member 52 by rotation connector 68 to allow for folding downward into the open configuration of FIG. 5. Any suitable rivet, bolt, bearing, or rotatable hinge can be used as the connector 68.

In embodiments of this invention, a locking pin is used to maintain the arms 60 and 62 in the extended and/or closed/storage positions. As an example, for each outrigger arm, a bolt through an opening in the arm and the support member can be used to keep it in the storage position. The bolt can be loosened or removed to deploy the arm. The same bolt or a different both can be used in the same opening in the arm and a different hole in the support member to lock the arm in the deployed position. This procedure can be repeated for the second arm, and reversed to return the arms to the storage position.

Various sizes, shapes, and configurations are available for the outrigger arms, depending on need. The arms can include shaped ends, such as with rubber or equivalent feet, to improve contact with the ground or other surface. The arms can also be telescopic instead of rotational, such as including a plurality of nested segments that can be extended outward and preferably angled toward the ground. The outrigger structure can also be embodied as two hinged extensions that fold outward.

As shown in FIGS. 2-4, the outrigger arms 60 and 62 are stowed vertically within the standing A-frame, such as generally parallel to the side rails 30 and 32. As shown in FIG. 3, two quarter-inch bolts with nuts are installed into each of the two side rails and the first step to secure the support member 52. When the outrigger arms 60 and 62 are released, they may be independently deployed to touch the support surface as shown in FIG. 5. The outrigger arms 60 and 62 are secured in the extended position by any suitable means, such as a bolt that fits through an opening 70 and 72 in the arms 60 and 62, respectively, that corresponds with openings 74 and 76, respectively in the support member. The bolt can use a nut or a cotter pin, or equivalent, to secure the arms in the extended position.

In embodiments of this invention, the outrigger bolt-holes 70 and 72 should be located at least three inches away from the rotation point or rivet 68 and no less than two inches from the edge of the support member 52. For a perfectly flat contact surface, pre-drilled and located bolt-holes may be provided by the manufacturer of the accessory. Otherwise, any terrain may be practically accommodated.

In some embodiments of this invention, an alarm mechanism is included to alert if the arms are not properly deployed. The alarm can be audible (a chime or siren) and/or visible (a light). As shown in FIG. 2, an alarm 80 is included on the support member 52. The alarm 80 has electrical sensors or contacts 82 in communication with the openings 74 and 76 to detect that the arms are deployed. Alternatively or additionally, the electrical contacts can be in communication with the openings 70 and 72 to detect a bolt therethrough. The electrical contacts can be at both positions, and create a circuit when the arms are properly stored and/or deployed, with an audio or visual confirmation when the arms are in proper position and/or secured.

Thus, the invention provides an apparatus for supporting a ladder. The outrigger structure of this invention can be easily attached to existing ladders, or integrally manufactured with new ladders.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. An apparatus for stabilizing a ladder having rung steps extending between opposing side rails, the apparatus comprising:
a support member configured to mount to at least one of the side rails of the ladder; and
an outrigger arm mounted to the support member, wherein the outrigger arm is extendable between a storage position and an extended outrigger position.

2. The apparatus of claim 1, wherein the outrigger arm is rotatably mounted to the support member, wherein the outrigger arm is rotatable between a storage position and an extended outrigger position.

3. The apparatus of claim 1, wherein in the storage position the outrigger arm is substantially parallel to and/or disposed between the opposing side rails of the ladder.

4. The apparatus of claim 1, further comprising a second outrigger arm rotatably mounted to the support member or a second support member.

5. The apparatus of claim 1, wherein the support member extends between the opposing side rails.

6. The apparatus of claim 5, further comprising a second outrigger arm rotatably mounted to the support member, wherein the second outrigger arm is rotatable between the storage position and a second extended outrigger position.

7. The apparatus of claim 1, wherein in the storage position, the outrigger arm and the second outrigger arm are disposed between the opposing side rails along a longitudinal axis of the ladder.

8. The apparatus of claim 1, wherein the outrigger arm is connected to the support member by and rotatable about a bolt, rivet, or rotatable hinge.

9. The apparatus of claim 1, wherein the support member is a support plate that reinforces the base of the opposing side rails and a bottom rung step.

10. The apparatus of claim 1, wherein a rotation axis of the outrigger arm is substantially parallel to a longitudinal axis of each of the opposing side rails.

11. The apparatus of claim 1, further comprising an alarm mechanism in combination with the outrigger arm and configured to alert if the arms are not in the proper position.

12. An apparatus for stabilizing a ladder having rung steps extending between opposing side rails, the apparatus comprising:
a support member having opposing ends each adapted to connect to one of the opposing side rails; and
a pair of outrigger arms each rotatably mounted at a first end to the support member, wherein the outrigger arm is rotatable between a storage position between the opposing side rails and a radially extended outrigger position.

13. The apparatus of claim 12, further comprising an alarm mechanism in combination with the outrigger arm and configured to alert if the arms are not in the proper position.

14. A method of stabilizing a ladder having rung steps extending between opposing side rails, the method comprising:
providing an outrigger arm with a first end connected to the ladder;
placing ends of the opposing side rails on a surface;
extending a first outrigger arm radially outward from the side rails; and
placing a second end of the first outrigger arm against the surface to stabilize the ladder.

15. The method of claim 14, further comprising automatically indicating and alerting if the outrigger arm is not secured in the extended position.
